(19) United States
(12) Patent Application Publication
(10) Pub. No.: US 2011/0086334 A1
(43) Pub. Date: Apr. 14, 2011

(54) Chez Educational System

(76) Inventor: Rhonda Lee Bell, Sheridan, WY (US)

(21) Appl. No.: 12/550,390

(22) Filed: Oct. 10, 2009

(51) Int. Cl. G09B 5/00; G09B 7/00

(52) U.S. Cl. 434/307 R; 434/322

(57) ABSTRACT

The educational system is an educational delivery system through the use of “live” video instruction by a certified instructor and is coordinated with specific sequential support materials for the student as directed by a facilitator of the program. The curriculum is created and performed by the “live” instructor. The prototype curriculum employs a chemistry content titled The Journey Chez Chem. The curriculum is designed to fit into a traditional two-semester year that is split into four quarters. Each lesson has a code that follows through the school year, beginning with 1-1-1 (Quarter 1-Week 1-Day 1) and ending with 4-9-5 (Quarter 4-Week 9-Day 5). The prototype package includes assessments, grade sheets, quizzes, laboratory exercises, answers, and point rubrics that allow the educator to analyze a student's overall performance throughout the course. Each content area would have specific requirements and support materials as created and performed by the “live” instructor.

### CROSS-REFERENCE TO RELATED APPLICATIONS

The following patents are related to this invention as they are educational, using methods of instruction and audio-visual teaching methods:

| | | |
|---|---|---|
| 5,244,394 | September 1993 | Serabian-Musto; |
| 6,669,486 | December 2003 | Frankenbery, et al. |
| 5,433,614 | July 1995 | Beye |
| 4,804,328 | February 1989 | Barrabee |
| 5,626,477 | May 1997 | Adkison |

### BACKGROUND OF THE INVENTION

The present invention relates to educational materials. More particularly, the present invention pertains to a novel system of educational delivery to children. The home school market lacks in-depth science education. Programs that mirror the quality education public and/or private schools offer are rarely developed. Parents and tutors who home-school children search for relevant, thorough curriculum to provide their students a high level of education that equals the lessons taught in public and/or private schools. The prototype of this invention is based on the material found in The Journey Chez Chem whose copyright registration numbers are: PAu3-407-345 and TXu1-613-522.

In order for the subject matter to be taught, the learning process must be pedagogically applicable to the student. This educational system allows for any adult to present subject matter to a student that is parallel to that instruction in a public school system as presented by the teacher in the public and/or private schools. The subject matter is “credited” as taught by a teacher certified in public and/or private school.

### BRIEF SUMMARY OF THE INVENTION

The Chez Educational System is a system of integration of teaching methods that have been proven over time with a technological advantage. To have the instruction available “live” on a video allows students to review the as needed. Each student has different learning styles, giving a student the ability to watch a lesson at their own pace with the needed paperwork and guidance from an adult provides the best of all possible options. The code that is used throughout the invention allows all parties to be organized and pursue the content in a sequential, methodical way. The instructor provides the content, practice, and assessments required for the student to learn and be assessed on content mastery.

### DETAILED DESCRIPTION OF THE INVENTION

The Chez Educational System is a new educational delivery system. Chez (Shea) is used to identify the system being employed. This system uses a “live” video instructor who is certified in the public school system of the United States. The “live” instructor has a persona that is caring and joyful and it is apparent to those involved in taking the course. The instruction is coordinated with the sequential support materials that are needed by the instructor to deliver the content information. The system provides for student practice, assesses student performance routinely, and provides answers to all materials to enable a facilitator to administer the program to a student. All required lessons are presented by the “live” instructor and the student is guided through the materials by a facilitator. The coursework is parallel to what the certified instructor requires of students in the pubic school setting.

The sequential code enables the instructor to coordinate the instructional materials for a full year of coursework. The code is shown to allow the student, facilitator and instructor to be on the same page of instruction throughout the course. This organization is a critical organizational component for all parties involved in the instruction of the student in the specific coursework.

There are many educational programs available; however, this program allows for the daily school routine that is normal for students in the public school sector. It also allows for the time required for a student to be able to assimilate the content and be assessed on mastery of the content in a timely fashion.

The introduction and trailer in each lesson provides a joyful environment and encouragement to students. It sets the tone of the class as well as being a connection to the instructor. It is well documented in the educational arena that the Pygmalion effect is indeed real and enhances the learning process. Each lesson has an introduction and trailer that is different and provides an additional motivation for the next lesson.

Teachers in small schools who teach other subjects can easily learn this system's methods, and can teach their own students the lessons. Parents can easily act as a facilitator to teach for a plurality of content areas.

Teachers of most any content can use this system as a method to provide the content of their subject to students.

### SUMMARY OF INVENTION

The present invention relates to an educational system that allows for the instruction of subject matter by a certified teacher. This system allows for home school students to level the playing field in terms of content delivered in the public and/or private school system in content areas that have been difficult to present outside of the public and or private school environment. It is also useful for classroom teachers as well as remediation for college students.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An educational system comprising:
(a.) a plurality of video lessons as performed by the “live” certified teacher to deliver subject content for display upon a video display surface, selected from a group consisting of a television monitor, a computer monitor, and a liquid crystal display;
(b.)said “live” teacher directing said student to view each lesson in sequence;
(i.) said lesson beginning with a fifteen to twenty-five second video of a themed, musical introduction of content with the topic number with the school day lesson code;
(ii.) a lesson code comprised of a sequential numerical representation with the format of quarter, week, and day of lesson for a two semester curriculum;
(iii.) a welcome by said teacher with a request for said student to do the warm up activity with said student's best effort and a promise by said teacher to return;
(iv.) a fixed document with a cartoon character displayed briefly with two warm up questions, objective, lesson code and daily assignment;
(v.) said teacher reviews answers to warm up questions with review of previously learned information;
(vi.) new material is taught by said teacher;
(vii.) relevant activities and/or laboratories are performed by the said teacher and said student uses the relevant data to complete the activity;
(viii.) encouragement by said teacher for said student to do what is required and expectation that said student will perform well;
(ix.) a 15-20 second trailer of theme with music and a statement by said teacher inviting the student to return for the next lesson.

2. The educational system according to claim 1; said lessons are facilitated by an adult to direct said student in assimilating and learning the content;

3. The educational system according to claim 1; the curriculum content containing a plurality of support materials, to include assessments, grade sheets, quizzes, laboratory exercises, answers, and point rubrics as written by said teacher;

4. The educational system according to claim 1; whereas this prototype is in the chemistry content area it is possible to produce this educational system of instruction in a plurality of content and subject areas.
